(19) United States
(12) Patent Application Publication
(10) Pub. No.: US 2010/0138068 A1
(43) Pub. Date: Jun. 3, 2010

(54) APPARATUS FOR TRANSFER OF ELECTRICAL ENERGY AND INFORMATION

(75) Inventor: Madhukar Puniani, Indianapolis, IN (US)

Correspondence Address: BACON & THOMAS, PLLC, 625 SLATERS LANE, FOURTH FLOOR, ALEXANDRIA, VA, 22314-1176, US

(73) Assignee: Endress + Hauser Wetzer GmbH + Co. KG, Nesselwang (DE)

(21) Appl. No.: 12/733,050

(22) PCT Filed: Jul. 11, 2008
(86) PCT No.: PCT/EP2008/059131

§ 371 Date: Feb. 4, 2010

(30) Foreign Application Priority Data
Aug. 10, 2007 (DE) 102007038060.9

(51) Int. Cl. G06F 1/26

(52) U.S. Cl. 700/295

(57) ABSTRACT

An apparatus for transfer of electrical energy and data between a primary side and a secondary side. At least one transferring unit is provided between the primary side and the secondary side, that, on the secondary side, at least a first data channel is provided, which has at least one address, that, on the primary side, at least one frequency control unit is provided, which is embodied in such a manner, that the frequency control unit sets the working frequency of the transferring unit in accordance with the data to be transferred and/or in accordance with the addressing at least of the first data channel, that, on the secondary side, at least one load tuning unit is provided, which is embodied in such a manner, that the load tuning unit sets the electrical load, which lies on the secondary side of the transferring unit, in accordance with the data to be transferred and/or in accordance with the address at least of the first data channel.

The invention relates to an apparatus for transfer of electrical energy and data between a primary side and a secondary side.

In modern process, and automation, technology, a variety of measuring devices, or data logging devices, are used, in order to monitor and control processes or to record happenings. If the medium or the process to be monitored is located in an explosion endangered area, then, most often, galvanic isolation is required, through which, nevertheless, energy and information, or data, must still be able to be transferred to the field devices located in the explosion endangered area.

Known in the state of the art, for this, are already a number of options; see e.g. DE 2 321 900, EP 0 977 406 A1 or EP 0 927 982 B1. These embodiments are, however, very complicated and costly. Another option is to transfer required energy via a transformer as transfer agent and the data via optocoupler, wherein, on each side of the galvanic isolation, a corresponding unit is used, in order to enable bidirectional, data transfer. Such a “safe isolation” is very consuming of space and, also, expensive, because of the increased component requirements.

Frequently, it arises, that, in the actual explosion endangered process, a larger number of measuring devices, or field devices, are present, which, correspondingly, have to be supplied with energy, or with which communications must be possible. If each of the field devices needs its own energy supply, or communication device, then this is likewise connected with costs and space requirements.

An object of the invention is to provide galvanic isolation between an explosion-endangered zone and a non-explosion endangered zone, via which information and energy can be transferred and which permits, additionally, the connection of a plurality of field devices on the secondary side.

The invention solves the object by the features that: At least one transferring unit is provided between the primary side and the secondary side; on the secondary side, at least a first data channel is provided, which has at least one address; on the primary side, at least one frequency control unit is provided, which is embodied in such a manner, that the frequency control unit sets the working frequency of the transferring unit in accordance with the data to be transferred and/or in accordance with the addressing at least of the first data channel; on the secondary side, at least one load tuning unit is provided, which is embodied in such a manner, that the load tuning unit sets the electrical load, which lies on the secondary side of the transferring unit, in accordance with the data to be transferred and/or in accordance with the address at least of the first data channel.

An idea of the invention is, thus, that information is transferred from the primary side to the secondary side via modulation of the working frequency and that, from the secondary side to the primary side, load change serves for transfer of the data. For the connection of a plurality of channels—thus of a plurality of field devices or components of field devices—an addressing is provided. Via the addressing, targeted accessing of individual channels becomes possible, or it becomes possible on the primary side to obtain information concerning from which data channel the information originates. I.e., via the addressing, or the address, a unique associating between data/information and source, or receiver, is given.

An embodiment provides that, on the secondary side, at least a first data channel and at least a second data channel are present, each of which has at least one address of its own. Via a number of data channels, thus, a number of field devices can connect to one interface, wherein, with each having its own addresses, also a safer associating of the data is possible.

An embodiment includes that the first data channel and the second data channel are embodied in such a manner, that the first data channel and the second data channel are isolated galvanically from one another. Preferably, the transferring unit provides galvanic isolation between the primary side and the secondary side. In this embodiment, thus, furthermore, also at least two data channels are galvanically isolated on the secondary side from one another. The same is true for further data channels.

An embodiment provides that the frequency control unit is embodied in such a manner, that: The frequency control unit sets the working frequency of the transferring unit in accordance with the data to be transferred and/or in accordance with the address of the data channel, or the addresses of the data channels, for which the data are intended; the load tuning unit is embodied in such a manner, that the load tuning unit sets the electrical load, which lies on the secondary side of the transferring unit, in accordance with the data to be transferred and/or in accordance with the address of the data channel or the addresses of the data channels, from which the data come. In this embodiment, thus, a number of data channels are provided on the secondary side, which, for example, supply the energy to, or the communication with, correspondingly many field devices. In the data communication, in each case, preferably the address of the data channel is transmitted, for which the data are intended, or from which the data comes. In an embodiment, it can also be provided, that the transfer of the address is omitted, when, for example, generally valid information is involved. In this embodiment, thus, it is, especially, provided, that there is, on the primary side, only one connection, which permits both energy supply of, or communication with, at least two units on the secondary side.

An embodiment includes, that at least the first data channel is embodied in such a manner, that the first data channel transfers data via the transferring unit only after a preceding addressing of the primary side via the transferring unit. Especially with reference to the load change, it is required, in order to avoid ambiguities, that not all data channels simultaneously transmit, or simultaneously change the load. This is, here, prevented by the feature, that only that data channel sends, i.e., transfers data, which has been addressed previously by the primary side. In other words, only the data channel, to which a request has been directed, reports and gives a response.

An embodiment provides that the transferring unit is embodied in such a manner, that the transferring unit effects galvanic isolation between the primary side and the secondary side.

An embodiment includes, that the load control unit is embodied in such a manner, that the load control unit, for transfer of data and/or addresses, performs a steep-flanked and/or short-time change of the load.

An embodiment provides that the transferring unit includes at least one transformer.

An embodiment includes, that the data to be transferred involves at least measured values and/or measurement parameters.

An embodiment provides that at least the first data channel and/or the second data channel includes at least one energy storer. The energy storer serves, in such case, preferably, for storing electrical energy and is, in the simplest case, at least partially, a capacitor. Since communication from the secondary to the primary side is performed via modulation of the load, this embodiment takes into consideration, that the field device connected with a given data channel can bring about a load change. This load change results, however, from the operating of the field device and should not be interpreted as information to be transferred from the primary side. The energy storer, thus, intercepts possible load changes of the field devices.

The invention will now be explained in greater detail on the basis of the appended drawing, the figures of which show as follows:

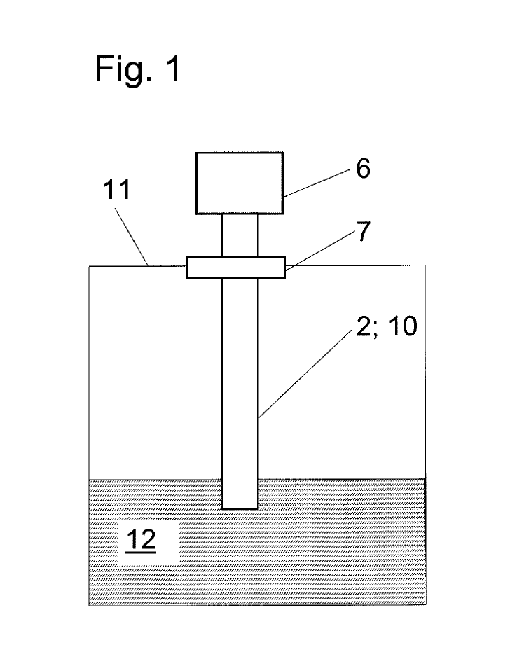

FIG. 1 a schematic drawing the apparatus of the invention;

and

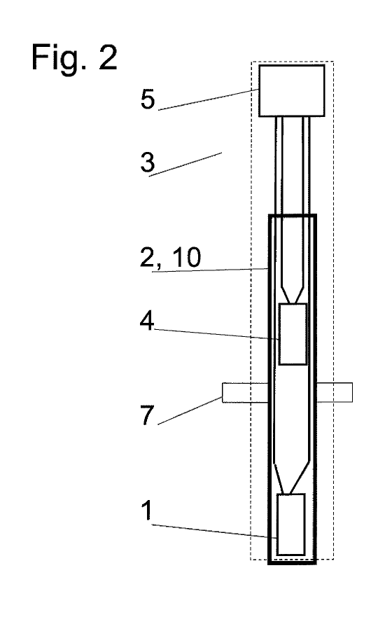

FIG. 2 a detailed embodiment of an apparatus of the invention.

FIG. 1 shows, schematically, the construction of the invention, via which a digital, bidirectional data stream (e.g. for parametering, or read-out of the measurement channels) is possible via a single, galvanically separated interface. A transferring unit 3 is located, here, between a primary side 1 and a secondary side 2. The two sides can, in such case, differ, as to whether they are, for example, explosion endangered. The primary side 1 is, here, for example, the non-explosion-endangered side. On this side is located, thus, for example, an energy source and/or a control station and/or a like control system, or a parametering input system. Thus, generally, the side, which the actual process or the region, in which the process to be monitored, or to be measured, is located. The process is located, in such case, on the secondary side 2.

On the secondary side 2, here, for example, two different sensors (e.g. a fill-level measuring device according to the radar principle and a temperature sensor) can be placed as examples for field devices 8, which must be supplied with energy. This energy supply is, in such case, performed via the transferring unit 3. Furthermore, however, also an information, or data, traffic must take place. This is required, for example, in order that the individual measuring devices on the secondary side 2 can transfer their measured values, or therefrom derived variables, to the primary side 1, thus, for example, to a control room. Conversely, it is required, that, in given cases, from the primary side 1 to the secondary side 2, measurement parameters or other values are transferred for control of the measurements. In such case, it is required, especially, that galvanic isolation exist between the primary side 1 and the secondary side 2. This galvanic isolation is accomplished, here, by a transformer 3.

Data transfer from the primary side 1 to the secondary side 2 occurs in that a frequency control unit 4 provided on the primary side 1 changes (according to FSK, or frequency shift keying) the working frequency of the transformer 3 in accordance with the information to be transferred. Thus, for example, two different frequency regions can be used, one being associated with a logic 1 and the other with a logic 0. Depending on complexity of the plant, however, also other information can be transferred.

Data transfer from the secondary side 2 to the primary side 1 occurs by short-time changing of the load on the secondary side 2. I.e., on the primary side 1, it is detected, that an increased electrical current requirement is present. This load change is detected on the primary side 1 and likewise transmitted correspondingly in logical signals.

On the secondary side 2 are located two different data channels 6, 7, which, for example, are provided for connection with the two different measuring systems. In alternative embodiments, more than two, or less than two, data channels are provided. In order that the data can be associated with the individual data channels, for example, before each data transfer, the address of the corresponding, or addressed or addressing, channel is transmitted. Thus, from the primary side 1 to the secondary side 2, that address of the data channel is transmitted, for which the data/information are intended. Conversely, in the case of transfer from the secondary side 2 to the primary side 1, always the address of the channel is transmitted, which is sending the information. In an additional variant, in given cases, transfer of the address is omitted, when information is involved, which can come from a plurality of data channels, or which, so-to-say, make general statements concerning the system, or when the information should be transferred from the primary side 1 to the secondary side 2 on a number of channels simultaneously. Besides the galvanic isolation between the primary side 1 and the secondary side 2, there is, preferably, also galvanic isolation between the two data channels 6, 7.

In order that a plurality of channels 6, 7 do not simultaneously perform a load change, it is provided in an embodiment, that only that data channel is permitted to transmit, which previously has received from the primary side 1 a corresponding polling signal or which actually has been addressed by the primary side 1. Thus, a master-slave architecture is provided, which, in each case, selects a channel for transfer.

FIG. 2 shows some details of the construction of the invention. In such case, a FSK-modulator 10 and a push-pull driver 17 are provided for the data transfer from the primary side 1 to the secondary side 2. The two allow the modulation of the working frequency of the transferring unit 3, in order to impress thereon the corresponding information, or data. These transmitted data are filtered back out on the secondary side 2 by an FSK demodulator 11 and made available to the corresponding device of the associated data channel 6, 7 in the form of a serial data stream.

Data transfer from the secondary side 2 to the primary side 1 is accomplished by switching an additional load 14 in the corresponding data channel, which brings about a short time load increase on the secondary side of the transformer 3. On the primary side 1, conversely, the electrical current is tapped, or measured by an electrical current sensor 18 and, via a differentiating member 19 and a signal former 20, which produces, from the short pulses of the differentiating member 19, a serial data stream, for example, fed to an evaluation unit, which correspondingly filters out from this load change the information, or the data, to be transferred, or the address of the data channel, from which the data comes,. In order to avoid, that a load change of the field device 8 connected with the respective data channel 6, 7 is interpreted as information to be transferred or as an address on the primary side 1, here, each data channel 6, 7 is provided with an energy storer 16, which provides a buffering of the energy required by the field device 8. In the illustrated case, this is, in each case, a capacitor, which is, here, part of the filter unit 15.

In data transfer, in an embodiment, first the information concerning the corresponding address of the data channel 6, 7, from which the data comes, or for which the data are intended, is transmitted and only after that is the actual data transferred. Used also for transfer is a protocol, which, in an embodiment, provides the transfer of the address. In such case, the data and the address are, in an embodiment, always transmitted in a packet. Which comes first, in such case, in the transfer, the address or the information, then does not matter; either order can be selected.

The apparatus of the invention is, in such case, implemented, for example, within a device. In an embodiment, it is placed on a circuit board. Or, it is a special device, which permits the connection between two zones, or between the two sides, as an interface.

### LIST OF REFERENCE CHARACTERS

1 primary side
2 secondary side
3 transferring unit
4 frequency control unit
5 load control unit
6 first data channel
7 second data channel
8 field device
10 FSK modulator
11 FSK demodulator
12 rectifier
13 barrier
14 supplemental load
15 filter
16 energy storer
17 push-pull driver
18 electrical current sensor
19 differentiator
20 signal former

1-10. (canceled)

11. An apparatus for transfer of electrical energy and data between a primary side and a secondary side, comprising:
at least one transferring unit provided between the primary side and the secondary side;
at least a first data channel provided on the secondary side, which has at least one address;
at least one frequency control unit on the primary side provided, which is embodied in such a manner, that said frequency control unit sets a working frequency of said at least one transferring unit, in accordance with data to be transferred and/or in accordance with addressing at least of said at least said first data channel; and
at least one load tuning unit provided on the secondary side, which is embodied in such a manner, that said at least one load tuning unit sets an electrical load, which lies on the secondary side on said at least one transferring unit, in accordance with data to be transferred and/or in accordance with the address at least of said at least said first data channel.

12. The apparatus as claimed in claim 11, wherein:
on the secondary side, said at least a first data channel and at least a second data channel are present, each of which has at least one address of its own.

13. The apparatus as claimed in claim 12, wherein:
said at least said first data channel and said second data channel are embodied in such a manner that said at least said first data channel and said at least said second data channel are galvanically isolated from one another.

14. The apparatus as claimed in claim 12, wherein:
said frequency control unit is embodied in such a manner that it sets the working frequency of said at least one transferring unit in accordance with the data to be transferred and/or in accordance with the address of the data channel or the addresses of the data channels, for which the data are intended; and
said at least one load tuning unit is embodied in such a manner, that it sets the electrical load, which lies on the secondary side of said at least one transferring unit, in accordance with the data to be transferred and/or in accordance with the address of said at least said first data channel or said at least said second data channel or the addresses of said at least said first data channels, from which the data come.

15. The apparatus as claimed in claim 11, wherein:
said at least said first data channel is embodied in such a manner, that it transfers data via said at least one transferring unit only after a preceding addressing of the primary side via said at least one transferring unit.

16. The apparatus as claimed in claim 11, wherein:
said at least one transferring unit is embodied in such a manner, that it effects galvanic isolation between the primary side and the secondary side.

17. The apparatus as claimed in claim 11, wherein:
said at least one load control unit is embodied in such a manner, that it performs a steep-flanked and/or short-time change of the load for transfer of data and/or addresses.

18. The apparatus as claimed in claim 11, wherein:
said at least one transferring unit includes at least one transformer.

19. The apparatus as claimed in claim 11, wherein:
the data to be transferred comprises at least measured values and/or measurement parameters.

20. The apparatus as claimed in claim 11, wherein:
said at least said first data channel and/or said second data channel includes at least one energy storer.
